(19) United States
(12) Patent Application Publication
(10) Pub. No.: US 2007/0064869 A1
(43) Pub. Date: Mar. 22, 2007

(54) Laminography apparatus

(76) Inventor: Richard Albert, Danville, CA (US)

Correspondence Address: THEODORE J. BIELEN JR., 1390 WILLOW PASS ROAD, SUITE 1020, CONCORD, CA, 94520, US

(21) Appl. No.: 11/407,303

(22) Filed: Apr. 18, 2006

Related U.S. Application Data
(60) Provisional application No. 60/672,858, filed on Apr. 20, 2005.

(51) Int. Cl. G01N 23/04

(52) U.S. Cl. 378/57

(57) ABSTRACT

A laminography apparatus utilizing at least a pair of detectors spaced from a source of X-rays. The X-rays emanate from a tube window and create images in the detectors. Optical gradients are removed from the images obtained by the detectors through a first computer program. The position of each of the detectors relative to the source of X-rays is also determined by a mask which permits a second computer program to process position information. In addition, the brightness of the images obtained by the detectors is adjusted using a third computer program based on any one of a number of detectors providing a brightness standard.

### BACKGROUND OF THE INVENTION

The present invention relates to a novel and useful X-ray laminography apparatus.

In the past, X-ray images have been obtained by X-ray imaging which does not employ laminographic techniques. However, such images are often difficult to interpret and, thus, do not provide critical information about a medical patient or about an inanimate object, such as one being examined for structural flaws. This is due to the fact that data originating from an internal structural region of an object being x-rayed may be obscured by overlapping or superimposed imaging of other regions adjacent to the region of interest.

Recently, tomographic imaging techniques have been developed that overcome conventional X-ray imaging. For example, computer aided tomography can generate a cross-sectional depiction of a single plane that is essentially free of data arising from other planes within the subject being examined. Prior tomographic installations required bulky, elaborate, and costly mechanical scanning systems. Generally, prior art tomographic installations included an X-ray source which directed a narrow X-ray beam to a detector at the opposite side of the subject being examined. The source and of the detector were then jointly translated relative to the subject, or the subject itself was translated. In this way, the X-ray beam was able to cut across a plane within the subject to be imaged. This method located points within a plane where a change of absorbency had been detected with respect to only one coordinate. Thus, a single translation of this type did not provide a meaningful tomographic or sectional image. Consequently, to obtain more information, with respect to a coordinate orthogonally located relative to the first translation, it was necessary to turn the source and detector angularly relative to the subject and repeat the translation. The location of particular points in both coordinates was then determined by data processing operations comparable to triangulation. Such mechanical positioning and scanning structure becomes even more complex if sectional images of more than one plane, or of oblique planes are to be generated from a single scanning sequence. In any case, relative motions involving source, detector, or sample, had to be utilized and always involved mechanical motions of these elements. Needless to say, such scanning X-ray installations are relatively large, complex, and costly. In addition, long periods of time are required to perform mechanical scanning operations of this type. The result is limited productivity and prolonged radiation exposure of the subject. Generally the effects of scattered X-rays decreases resolution in a tomographic image. Likewise, long exposure of subjects aggravates such resolution resulting in image degradation.

Reference is made to U.S. Pat. No. 4,730,350 which eliminated the motion of the subject being examined and/or the detector to generate tomographic image data. In that reference, a charged particle beam is directed to a broad target plate and raster scanned to produce a moving X-ray origin point. X-ray count values were obtained at a plurality of spaced part protection points situated at the opposite side of the subject from the source. Successive count values from such raster scanning provided a sequence of composite data values and allowed the construction of an image in a specific plane within the subject, with suppression of data from other planes within the subject.

The use of a much larger number of detectors than that described in the prior art presents new problems concerned with accurate positioning of such detectors, the removal of gradients in the images produced, and the balancing of brightness of the detectors located about an object being examined in an X-ray chamber. An apparatus which solve such problems would be a notable advance in the field of X-ray tomography.

### BRIEF SUMMARY OF THE INVENTION

In accordance with the present invention a novel and useful X-ray laminography apparatus is herein provided. The laminography apparatus of the present invention utilizes at least a pair of detectors, but is not limited to this number. The plurality of detectors are employed to image an object utilizing an X-ray source and a computer for processing data obtained from such detectors.

An X-ray tube window is formed in the chamber and is transparent to X-rays from a source which pass through the window. Means is employed to obtain first and second images from the first and second X-ray detectors acquiring X-rays passing through the X-ray tube window. Means is also found for removing an optical gradient from the first and second images which is inherent in the use of multiple detectors arranged around the object or subject being examined within the X-ray chamber. A first computer program is employed to remove the optical gradient from the first and second images utilizing a first algorithm. The first algorithm adjusts the intensity of portions of the first and second images relative to an intensity standard. Such adjustment is achieved by selecting a number of sections of equal area from the first and second images and adjusting the intensity of certain sections of the image relative to a standard section of each of the first and second images. Sections chosen in the first and second images are of equal area.

In addition, the apparatus of the present invention comprises means for locating the position of the first and second detectors relative to the X-ray source. Such positioning of the multiple detectors includes the utilization of a mask or finding fixture which is intermittently interposed the X-ray source and each of the multiple detectors. Such mask forms, in the case of the first and second detectors, first and second reference patterns in the first and second images obtained from the first and second detectors. The mask includes a frame and a first element held by the frame which is spaced from a second element, which is also held by the frame. The first element is proximately positioned relative to the X-ray source while the second element is distally positioned relative to the X-ray source. For example, the first element may comprise a square-like object while the second element may comprise a cross-like object. The relative positions of the first and second elements of the mask determines the position of a particular detector relative to the X-ray source. A second computer program is also employed in the computer and utilizes a second algorithm for locating the position of the first and second detectors relative to the X-ray source. The second algorithm employs the first and second reference patterns to achieve this result.

Moreover, the apparatus of the present invention also comprises means for adjusting the brightness of the first and second images relative to one another. Arbitrarily, the first image may be designated as a standard. A third computer program is then employed utilizing a third algorithm to obtain an operating setting of first detector and allows the operator of the apparatus of the present invention to adjust a similar operating setting of the at least a second detector in order to match the degree of brightness of the first detector. The algorithm employs a histogram of the first image which is comprised of a plurality of bins, each possessing a range of brightness for a particular number of pixels within the bin. Utilization of the elements of the apparatus of the present invention may be performed in a particular order in which certain elements may be used repeatedly. For example, the employment of means for adjusting the brightness of particular images relative to a standard image would fall into this category in many cases.

It may be apparent that a novel and useful apparatus for performing laminography on an object has been hereinabove described.

It is therefore an object of the present invention to provide an X-ray laminography apparatus which eliminates mechanical motions involved in prior art tomographic installations.

A further object of the present invention is to provide an X-ray laminography apparatus which is capable of accommodating a large number of detectors arranged around an object being examined in an X-ray chamber and obtaining an X-ray lamination image which is of very high quality.

Another object of the present invention is to provide an X-ray laminography apparatus which minimizes the X-ray radiation exposure of the object being examined.

A further object of the present invention is to provide an X-ray laminography apparatus which is capable of producing lamination images of exceptionally high quality by accurately locating the position of multiple detectors, adjusting optical gradients from the images, and adjusting the brightness levels of the multiple detectors during operation of the apparatus of the present invention.

A further object of the present invention is to provide an X-ray laminography apparatus which eliminates the need to physically measure the position of multiple detectors in an X-ray chamber in order to achieve the production of lamination images on an object being examined therewithin.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 is a side elevational view of a trio of detectors schematically depicted relative to an X-ray tube depicted in section within an X-ray chamber, as well as a computer shown apart from the X-ray chamber utilized to carry out the operations of the apparatus of the present invention.

FIG. 2 is a schematic representation of an optical gradient of an image obtained by detector depicted in FIG. 1.

FIG. 3 is a schematic view of an optical gradient of an image obtained by another detector depicted in FIG. 1.

FIG. 4 is a representation of an image obtained from a detector of the apparatus of the present invention divided into equal sections indicating intensity of portions of an image.

FIG. 5 is a representation of an image obtained from a detector of the apparatus of the present invention with an isolation of the edge portion thereof.

FIG. 6 is a flow chart representing the operation of the first algorithm, performing a calibration to remove an optical gradient from an image obtained from a detector of the apparatus of the present invention.

FIG. 7 is a flow chart representing the operation of the first algorithm applying a calibration for removing an optical gradient from an image obtained from the detector of the apparatus of the present invention.

FIG. 8 is a side elevational view showing the geometric relationship of a detector relative to an X-ray source on an X-ray tube.

FIG. 9 is a sectional view showing the mask employed to produce a reference pattern to discern the position of a detector in the X-ray chamber used in the apparatus of the present invention.

FIG. 10 is a sectional view taken along line 10-10 of FIG. 9.

FIG. 11 is a sectional view taken along line 11-11 of FIG. 9.

FIG. 12 is a representation of an image obtained from a typical detector of the apparatus of the present invention indicating that the detector is not perfectly centered over the X-ray source.

FIG. 13-17 are flow charts depicting the operation of the second algorithm to locate the position of the detector in an X-ray chamber relative to a source of X-ray radiation.

FIG. 18 is a representation of a pixel image of a particular bin employed to analyze the brightness of a portion of an image obtained from a detector in the apparatus of the present invention.

FIG. 19 is a layout of categories of pixels arranged according to brightness depicted in FIG. 18.

FIG. 20-23 are flow charts representing the operation of the third algorithm to adjust and balance the degree of brightness among a plurality of detectors in the apparatus of the present invention.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

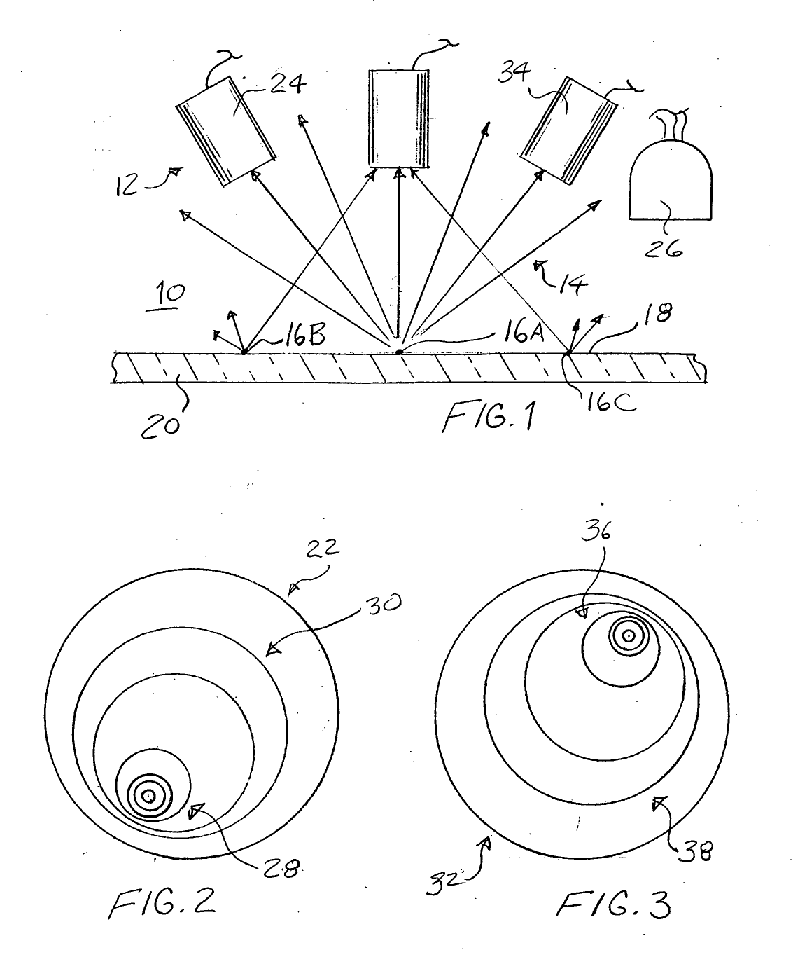

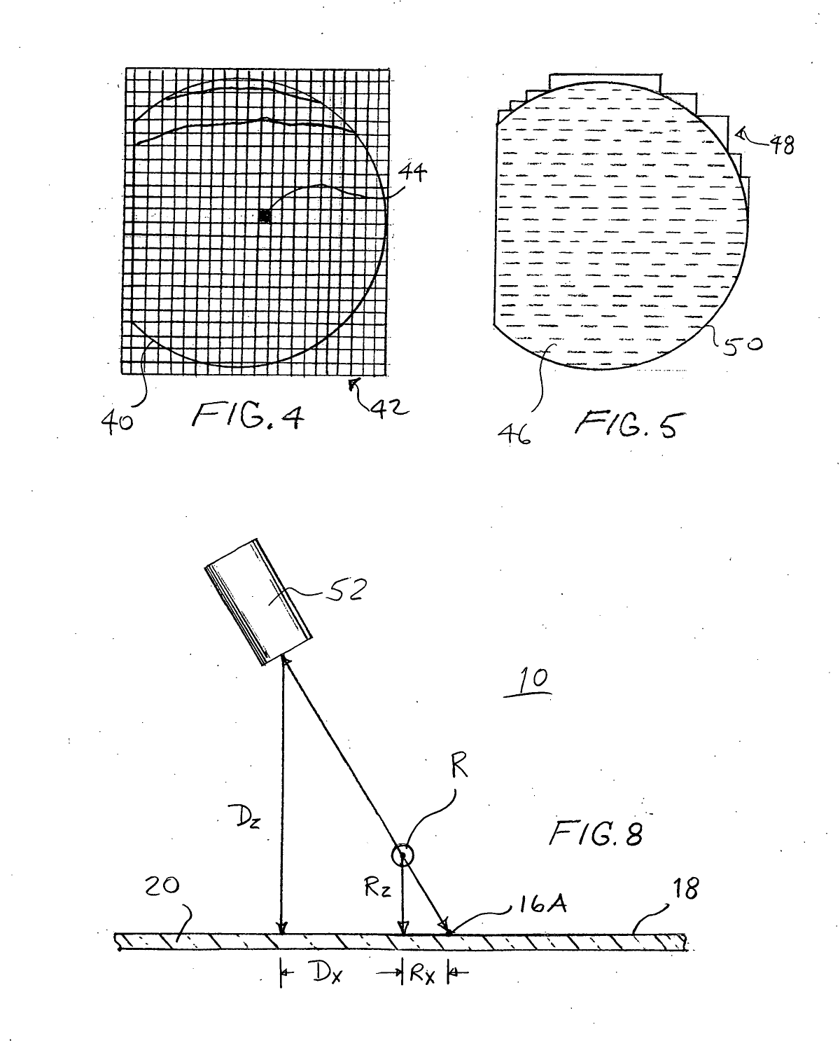

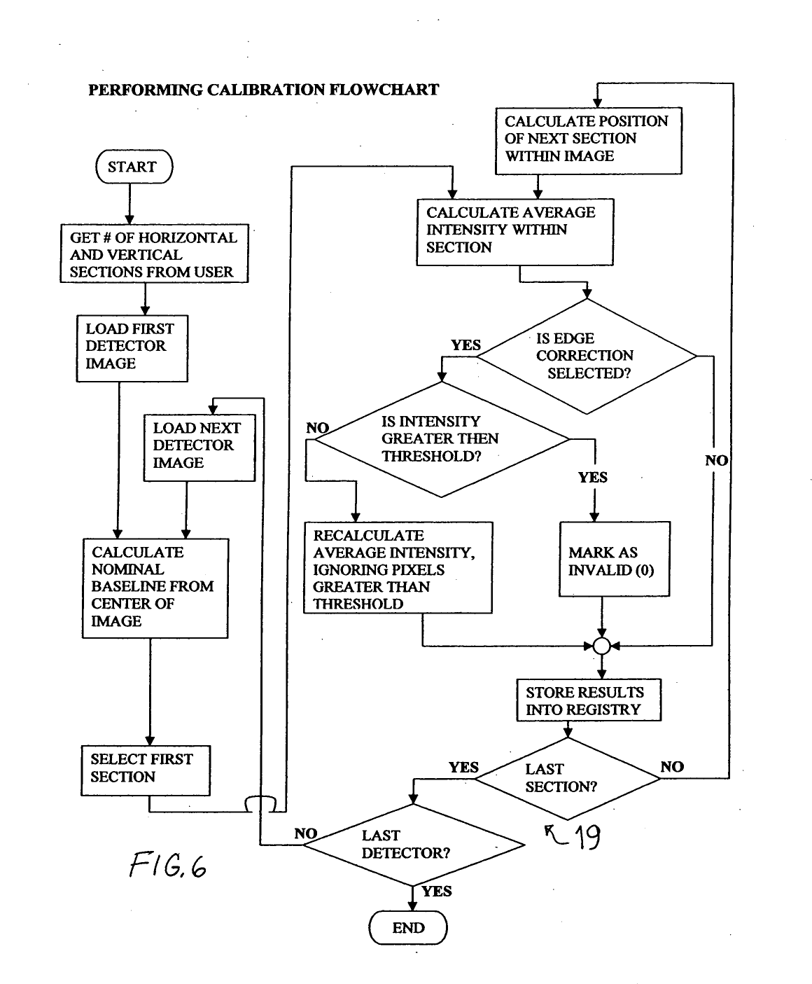

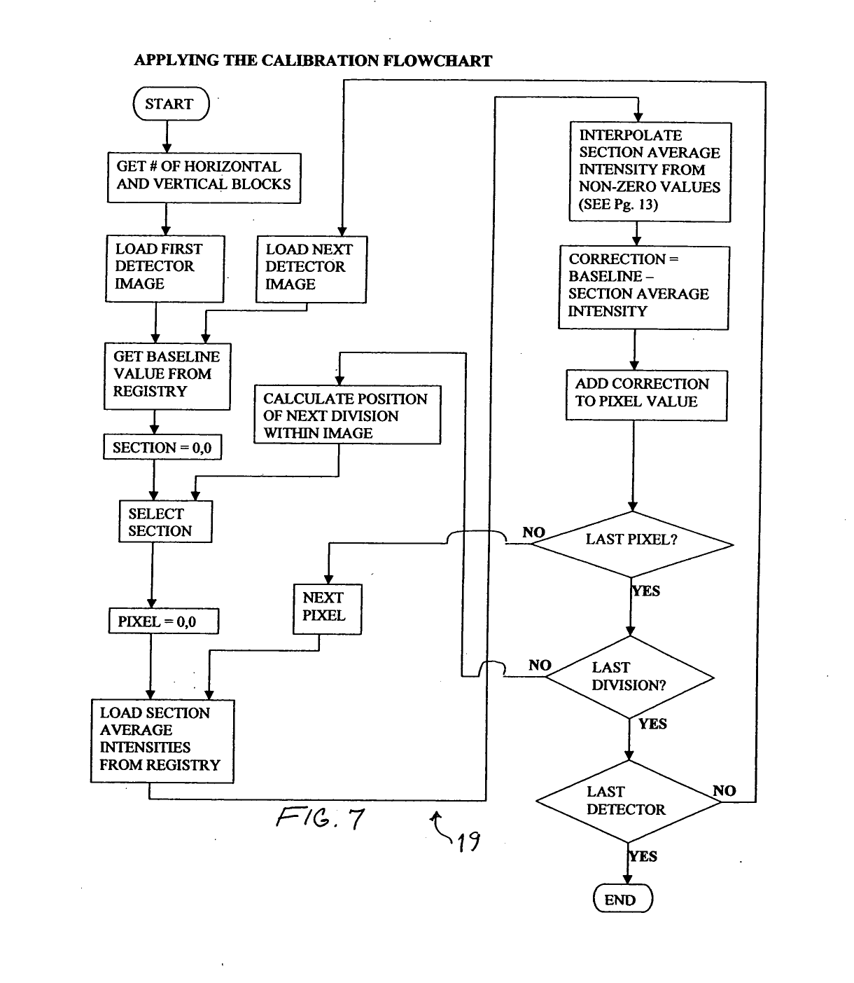

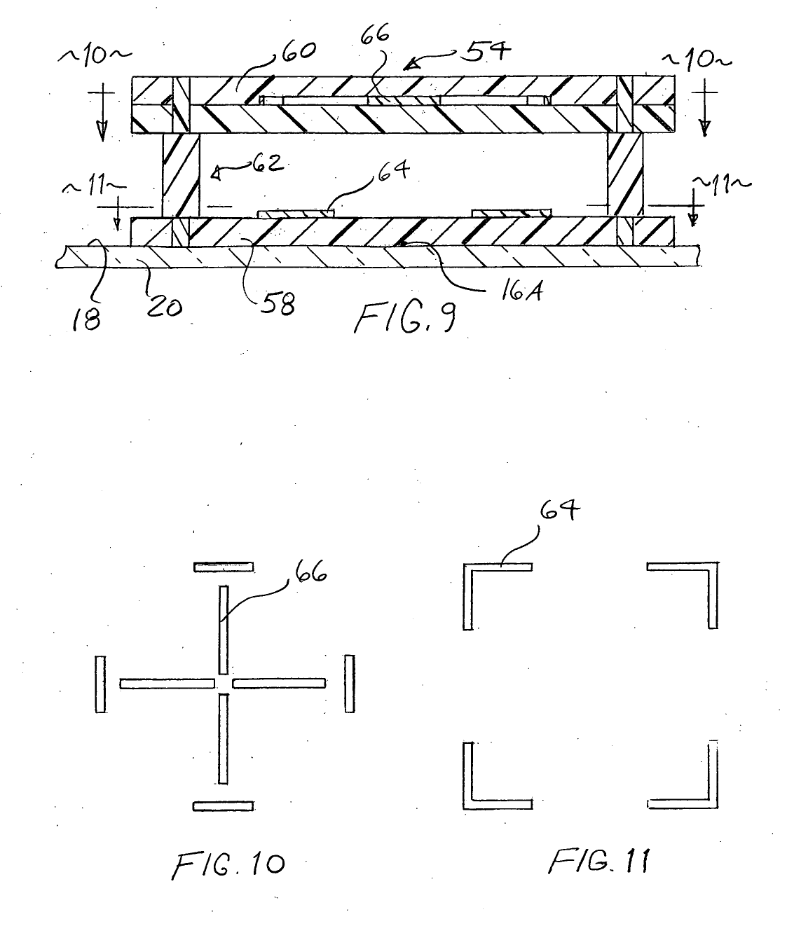

The apparatus of the present invention is used in an X-ray chamber 10, shown schematically in FIG. 1. The laminography apparatus 10 possesses a plurality of detectors 12 which are arranged in chamber 10 to receive X-ray radiation. Such X-ray radiation is denoted by a plurality of arrows 14 from an X-ray source 16 depicted as emanating from surface 18 of X-ray radiation tube window 20. Of course, X-ray radiation 14 is generated by an X-ray device, such a one described in U.S. Pat. No. 4,730,350, well known in the art. Needless to say, X-ray source 16 is a raster scan source which eliminates mechanical repositioning of detectors and the X-ray source relative to the object being scanned, as described hereinabove. In the present apparatus 10, multiple detectors 12 are arranged within X-Ray chamber 10 relative to X-ray source 16. For example, 64 detectors may be employed in X-ray chamber 10 depicted in FIG. 1. Many problems arise with the utilization of a large number of detectors 12. For example, optical gradients of the images obtained from detectors 12 must be removed. In addition, the position of detectors 12 must be accurately determined within X-ray chamber 10. Finally, the brightness of the images obtained from multiple detectors 12 must be balanced to provide consistency in the images in order to perform a lamination of the object being examined and obtained images which are of high quality.

With respect to removing optical gradients, the images obtained from plurality of detectors 12, three factors must be taken into consideration:
1. Variation in tube target thickness,
2. Variation in detector distance from the X-ray source 16 found on emission surface 18, and
3. Variation of angle of incidence between the detector and the radiation source.
   Means 19 is thus provided for removing optical gradients from images obtained by plurality of detectors 12. X-ray table 20 basically emits plurality of X-rays 14 from every point on surface 18. Such X-rays 14 emanate or radiate out from table 20 in all directions, with a raster pattern. FIG. 1 shows a portion of such raster pattern of X-ray sources. However only radiation source points 16a, 16b, and 16c are depicted. Optical gradients are produced on X-ray images due to the distance of any one of detectors 12 from radiation source 16a, 16b, or 16c due to X-ray tube anode thickness differences, and X-ray absorption, caused by the paths of X-rays 14 passing through to table window 20 at various angles. For example, FIG. 2 represents a typical image 22 produced by detector 24 in conjunction with computer 26. As may be observed, image 22 is shown with small circles 28 representing dark areas of image 22 while large circles 30 represent lighter or washed out areas. Likewise, image 32 of detector 34 shows dark areas represented by small circles 36 and lighter or washed out areas shown by larger circles 38. Thus, it is important to remove the errors due to optical gradients before lamination to produce an image which provides a sharper and more accurate representation of the object that is being scanned by the X-rays emanating from sources 16 a-c.

To achieve this result, images are obtained from a plurality of detectors 12 by mapping surface 18 of table 22 with no object present. The results are then stored in computer 26 for application to image data obtained for any object being X-rayed, under an identical set up of plurality of detectors 12 with X-ray sources 16 a-c within X-ray chamber 10. Turning to FIG. 4, it may be observed that for each detector of plurality of detectors 12, image 40 is divided into a plurality of equal sections 42 to calculate gradient. Plurality of sections 42 are obtained by divisions of XY axes, i.e. a two dimensional format. The average intensity for each section is then calculated and saved in a registry in computer 26. A center section 44 is typically used as a reference value and saved separately in such registry. In the center section, typically an area of 50×50 pixels is averaged to generate a baseline intensity value. A first algorithm is employed and used within computer 26 in a first computer program. The compact disk appendix to this application reveals the object code of such first computer program and such first algorithm. Thus, the intensity of portions of images, such as images 22 and 32 of FIGS. 2 and 3 are adjusted to produce a smooth image depicted as image 46 of FIG. 5. Such an adjustment occurs for all of the images of apparatus 10 obtained by plurality of detectors 12 as needed. It should also be noted that image data 48 beyond the edge 50 of image 46 is eliminated by the first algorithm, the process of which is depicted in FIGS. 6 and 7.

Means 51 is also provided for locating the position of any of said plurality of detectors 12. Turning now to FIG. 8, it may be seen that a detector 52 is shown as one of the plurality of detectors 12 of apparatus 10 of FIG. 1. An object R is placed in a known position relative to surface 18 of table or tube 20. In addition the quantity D_{Z} is also known. One can solve for the quantity Dₓ by using the following formulas:

$$\frac{{D}_{Z}}{{D}_{X} + {R}_{X}} = \frac{{D}_{Z} - {R}_{Z}}{{D}_{X}}$$

$$Solving for {D}_{X} : \\ {D}_{X} = \frac{{R}_{X} ( {D}_{Z} - {R}_{Z} )}{{R}_{Z}}$$

It should be apparent that one may solve for Dy in the same manner by simply shifting the representation depicted in FIG. 8 by 90° along surface 18 of table 20. Needless to say, the quantities D_{X} and D_{Y} are found along surface 18 of table 20 and, together with D_{Z}, determines the exact position of detector 52 relative to table 20 in X-ray chamber 10.

The information obtained with respect to detector 52, illustrated in FIG. 8 may then be obtained for each and every of the plurality of detectors 12 with an X-ray chamber 10. Such information, along with the size of table 20 and in particular surface 18 of table 20 fully defines the geometry of X-ray chamber 10. Such information permits the alignment of any X-ray images generated by detectors 12 to be predetermined for any particular focal plane to an object being examined in X-ray chamber 10. Once such alignment has been performed any object R may be placed in the X-ray chamber to produce lamination images.

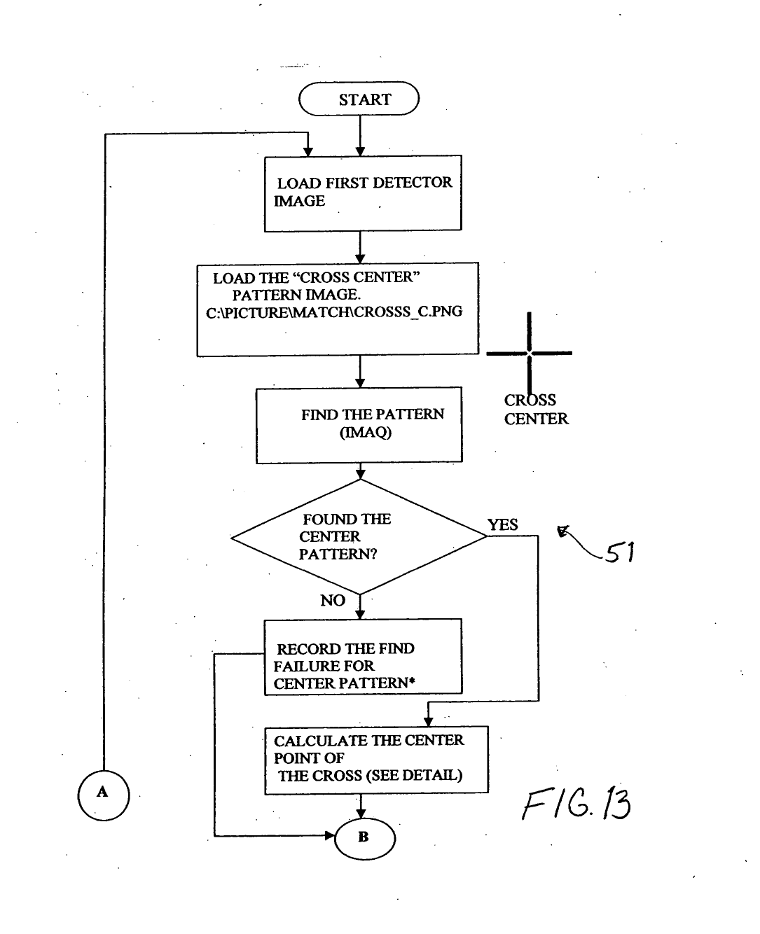

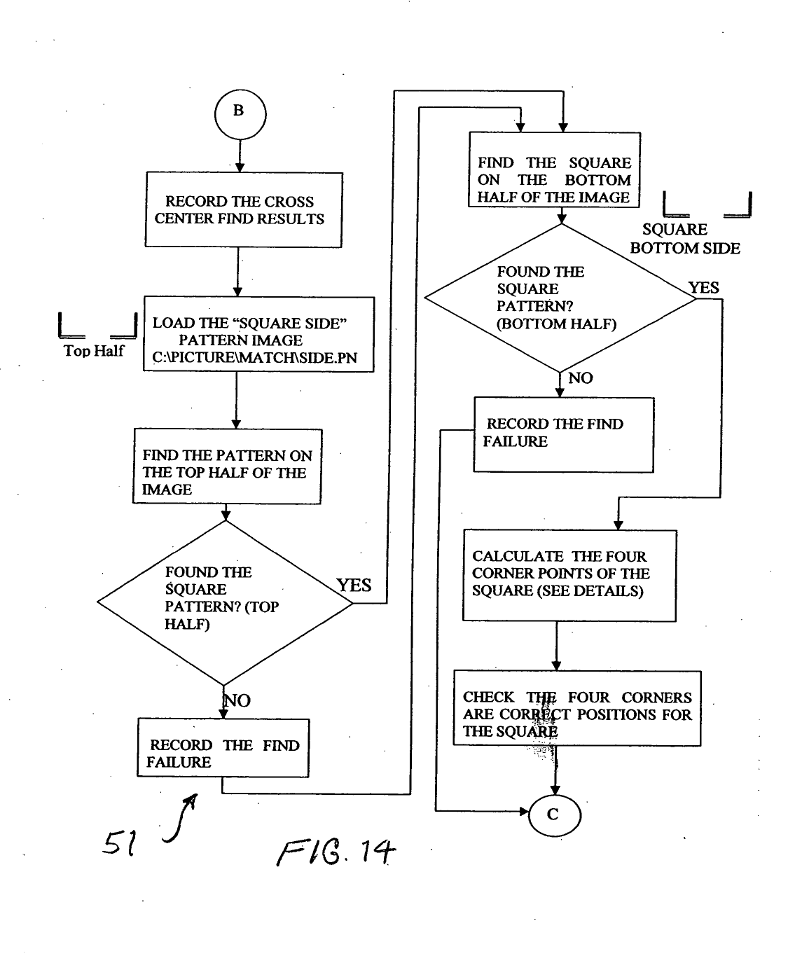

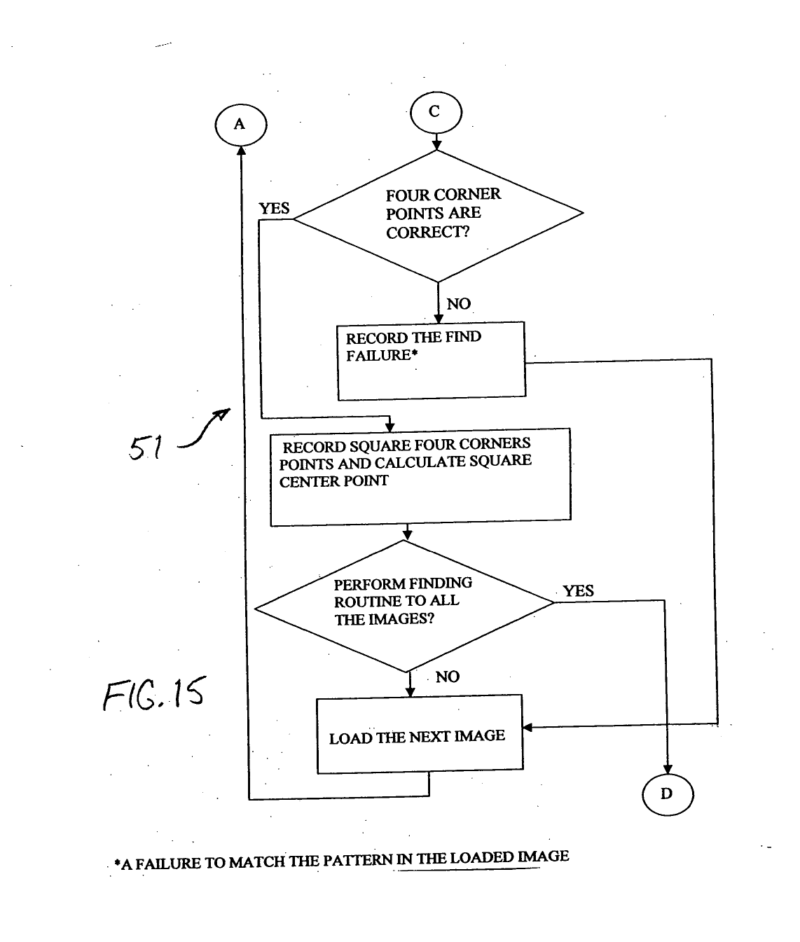

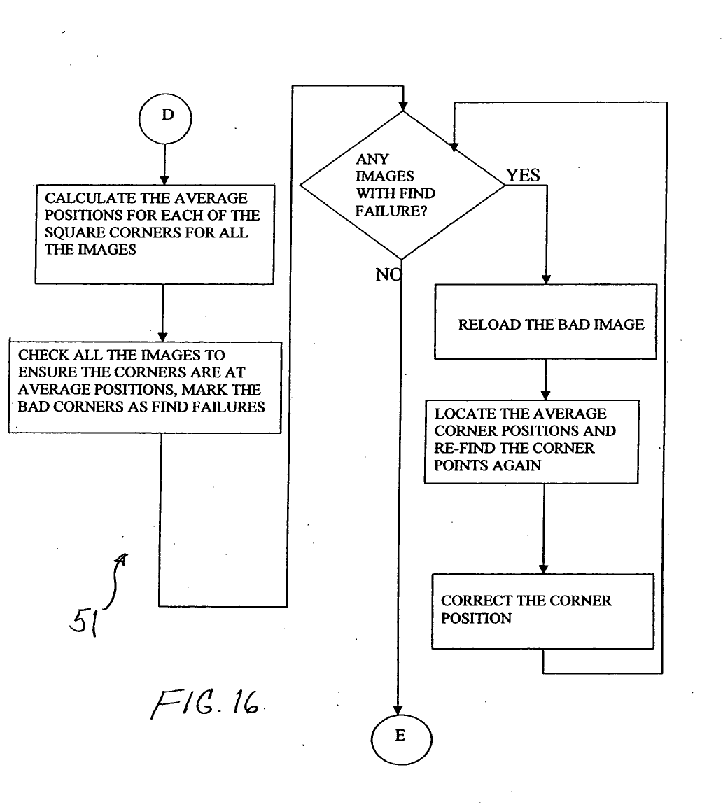

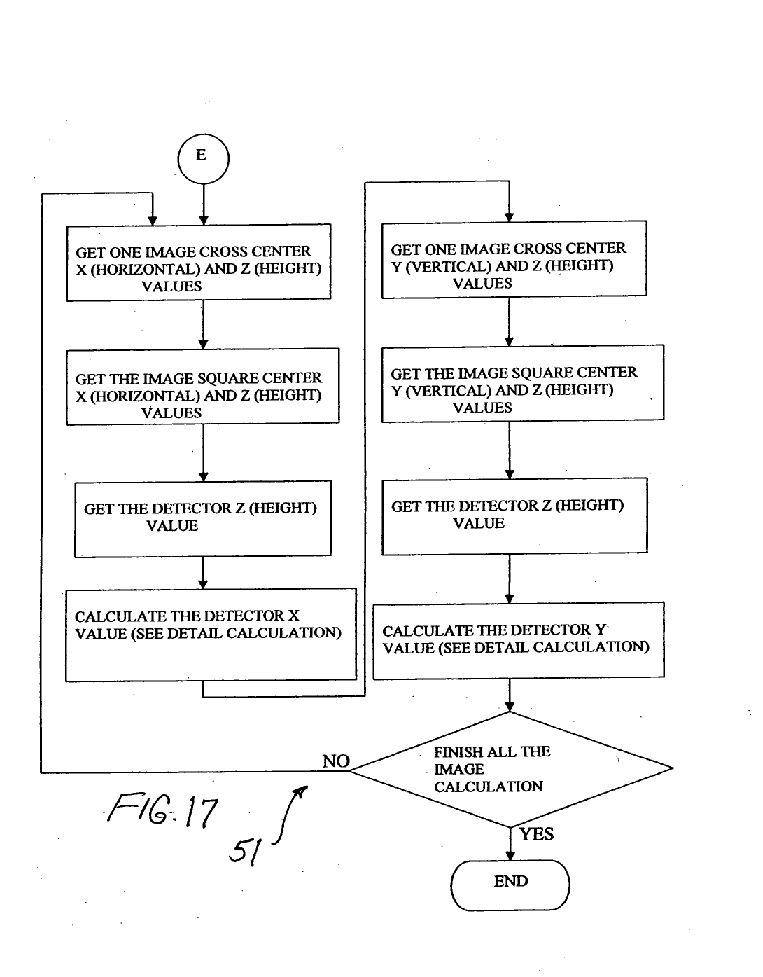

To eliminate physical mechanical measurement of the position of detector 52 in the X and Y, directions the present invention involves the employment of a finding fixture on mask 54 which sits atop surface 18 of table 20. Mask 54 is formed by a frame 56 having a lower portion 58 and an upper portion 60. A plurality of posts 62 separate lower portion 58 from upper portion 60. It should be understood that lower portion 58 and upper portion 60 of frame 54 are radiolucent. A first element 64 is held by lower portion 58 in spaced relationship to second element 66 held by upper portion 60 of frame 56. Elements 64 and 66 are radioopaque, such that element 64, proximal to radiation source 68, superimposes an image on element 66, distally located relative to radiation source 16a to produce a composite image obtained by any one of plurality of detectors 12. Turning to FIGS. 10 and 11, it may be further observed that element 64 is roughly in the shape of a rectangle or square while element 66 is roughly in the shape of a cross, FIGS. 10 and 11. FIG. 12 represents an image from one of the plurality of detectors 12 which is an off-center image. A second computer program utilizing a second algorithm locates the position of any one of the plurality of detectors by employment of the images obtained by mask 54, such as image 66 shown in FIG. 12. FIGS. 13-17 represent flow charts showing the operation of the second algorithm utilized to position any one of plurality of detectors 12 relative to X-ray table 20. The aforementioned CD appendix reveals the object code for the operation of the second computer program and second algorithm depicted in FIGS. 13-17.

Means 67 is also found in the present invention for adjusting the brightness of any image relative to another image obtained by plurality of detectors 12. Such balance or brightness adjustment employs individually adjustable photomultiplier tube operating voltages associated with each detector. It should be realized that computer 26 is also capable of automatically adjusting such operating setting of each detector or plurality of detectors 12. The auto-balance of the degree of brightness is achieved through a third computer program using a third algorithm, revealed in the aforementioned CD appendix. The third algorithm to auto-balance the brightness of any one of the plurality of detectors 12 employs a figure of merit (FOM) as a measure of image brightness. Any detector may be selected to produce a first image, which is manually adjusted for image quality using the photomultiplier voltage, offset, and gain, in the conventional manner. Such detector is then referred to as the master detector and the third algorithm is used to calculate a target FOM using this image. The third algorithm will then adjust the photomultiplier tube voltages of all the other detectors of plurality of detectors 12 to achieve a matching of the FOM for each image.

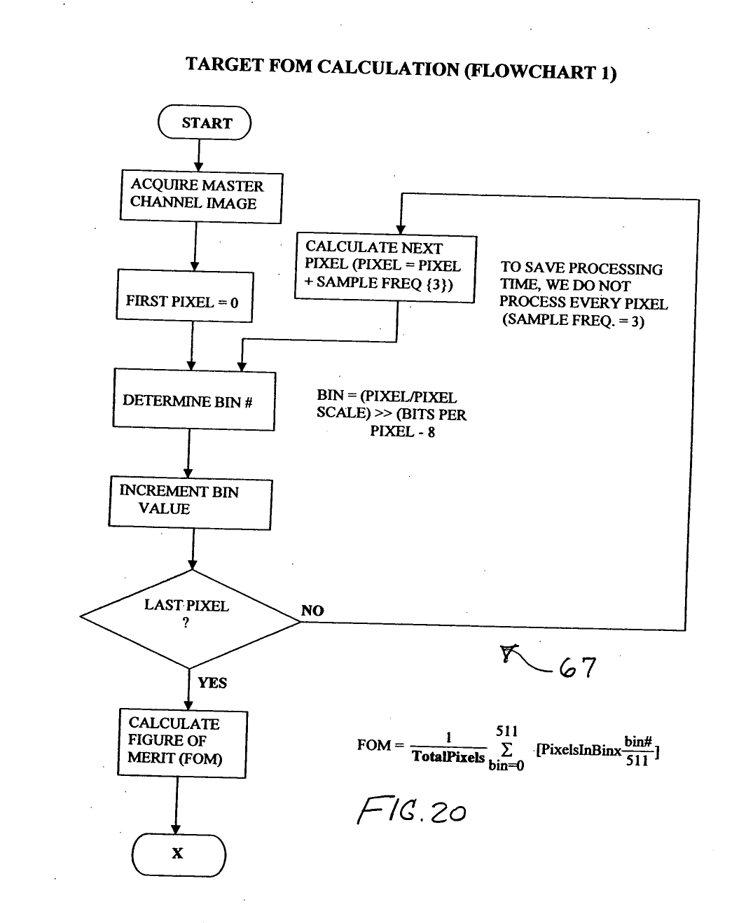

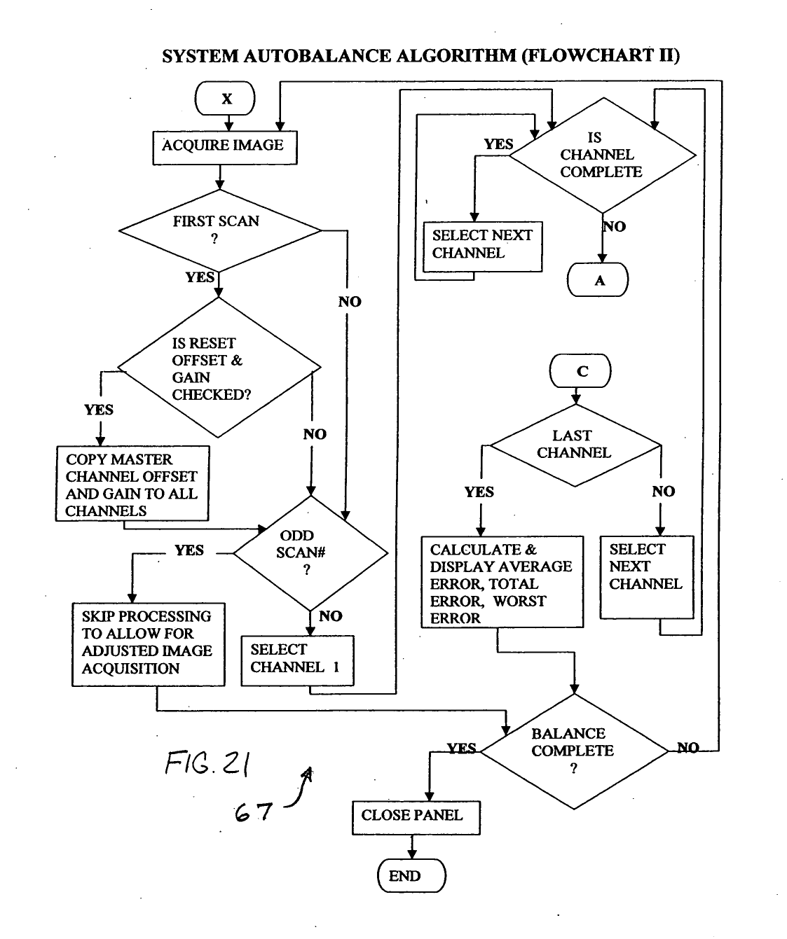

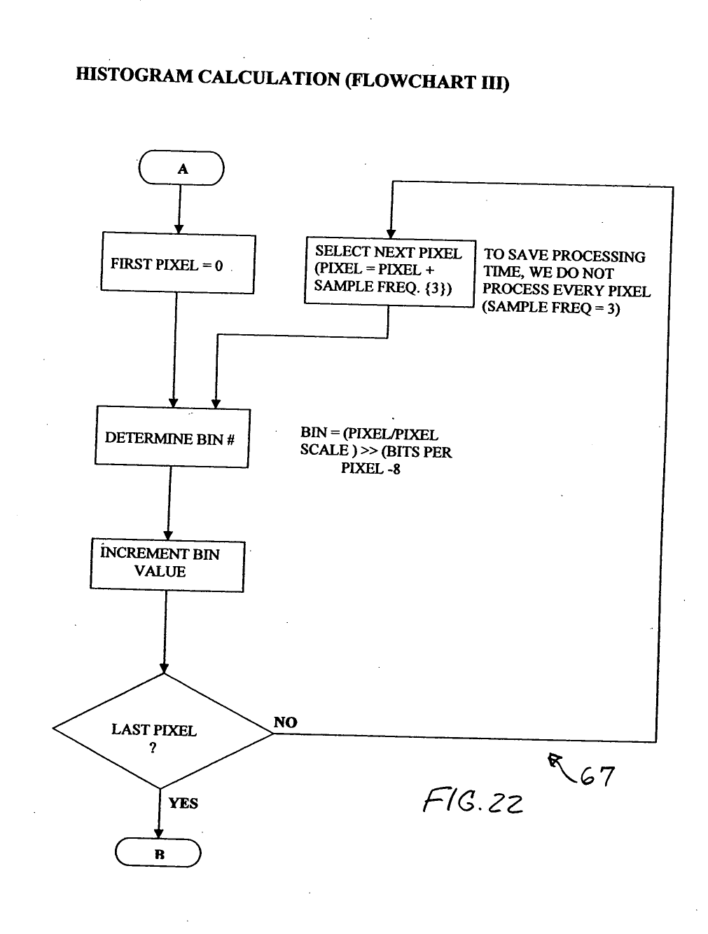

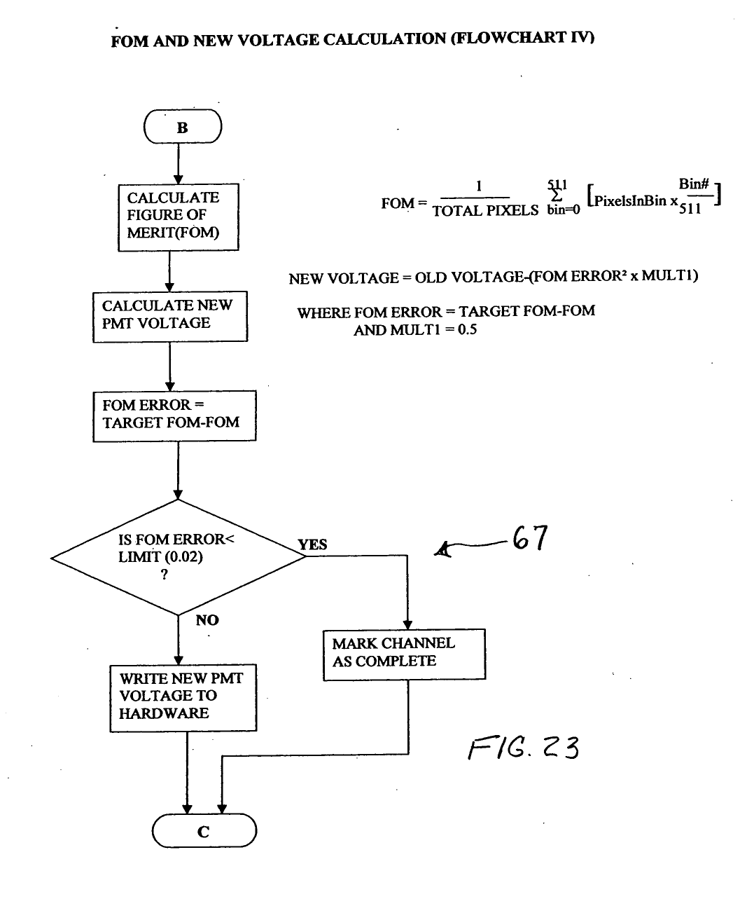

Referring to FIGS. 18 and 19, third algorithm adjusting the brightness balance of plurality of detectors 12 relies on the concept of a histogram made up of pixels separated into bins of brightness. FIG. 18 illustrates a typical bin having 40 pixel images separated into four levels of brightness. Such levels are delineated by numbers 1-4 and appear as a portion of FIG. 19. FIG. 19 constitutes a histogram showing the number of pixels in each category in a stacked configuration. There is a separate histogram for each detector image. In the third algorithm of the present invention, not every pixel is observed when calculating the histogram. For example, every third pixel is used and the brightness of the same is reduced to a 9-bit value. This data is employed to index and increment the array of histogram bins. FIGS. 20-23 represent flow charts showing the operation of the third algorithm to balance the degree of brightness of plurality of detectors 12 in X-ray chamber 10.

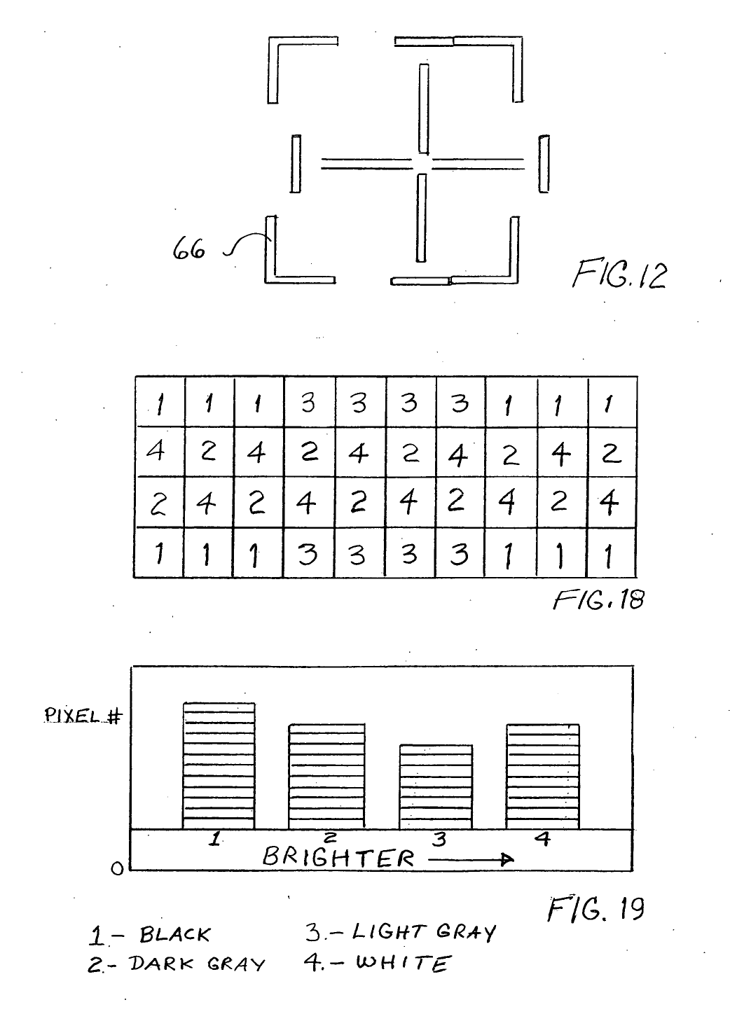

In operation, the user arranges a plurality of detectors 12 relative to surface 18 of X-ray table or tube 20. To achieve a lamination image of high quality one must employ means 19 for removing the optical gradients from the images of plurality of detectors 12 due to their position in X-ray chamber 10, means 51 for accurately locating the position of plurality of detectors 12 in X-ray chamber 10, and means 67 for balancing the degree of brightness of detectors 12 during the lamination process. This process takes place through the use of a series of computer programs each having an algorithm revealed by the CD appendix to the present application and shown in the drawings FIGS. 1-23. It may also be realized that the order of applying these steps to ensure that an accurate image is obtained with each object examined in the X-ray chamber 10 to assure that each detector is properly located, and the like. For example, a typical order of procedure is as follows:

a. place mask or finding fixture 54 on surface 18 of tube 20.

b. perform the brightness balance.

c. perform the location plurality of detectors 12.

d. remove the mask or finding fixture from surface 18 of tube 20.

e. perform the brightness auto-balance on plurality of detectors 12.

f. perform the lamination of the object through the raster scanning procedure.

g. remove the object from the X-ray chamber 10.

h. perform the auto-balance brightness adjustment to plurality of detectors 12.

i. apply the optical gradient removal to the plurality of images obtained from plurality of detectors 12 to produce a high quality lamination image.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. An X-ray laminography apparatus for imaging an object utilizing at least a first and a second X-ray detector spaced from a source of X-rays and a computer,
Comprising:
a. an X-ray tube window, the X-ray from the source of X-rays passing through said window
b. means for obtaining a first image from the first X-ray detector of X-rays passing through said window;
c. means for obtaining a second image from the second X-ray detector of X-rays passing through said window; and
d. means for removing an optical gradient from said first and second images.

2. The system of claim 1 in which said means for removing an optical gradient from said first and second images comprises a first computer program employed in the computer, said computer program utilizing a first algorithm to adjust the intensity of portions of said first and second images relative to an intensity standard.

3. The system of claim 2 in which said algorithm utilizes a select number of sections of equal area of said first and second images, employs a particular section for each of said first and second images as said intensity standard and adjusts the intensity of the remaining sections of equal area of said first and second images.

4. The X-ray laminography apparatus of claim 1 which additionally comprises means for locating the position of the first and second detectors relative to the X-rays source.

5. The apparatus of claim 4 in which said means for locating the position of the first and second X-ray detectors relative to the X-ray source comprises:
a. a mask intermittently interposed the X-ray source and the first and second X-ray detectors to form first and second reference patterns in said first and second images respectively.

6. The apparatus of claim 5 in which said mask comprises:
a. a frame,
b. a first element held by said frame proximally positioned relative to the X-ray source; and
c. a second element held by said frame distally positioned relative to the X-ray source.

7. The apparatus of claim 6 in which said first element comprises a square like object and said second element comprises a cross-like object.

8. The apparatus of claim 5 in which said means for location the position of the first and second detectors relative to the X-ray source further comprises a second computer program employed in the computer, and second computer program utilizing a second algorithm for locating the position of the first ans second detectors relative to the X-ray source based on said first and second reference patterns formed by said mask.

9. The apparatus of claim 1 which additionally comprises means for adjusting the brightness of said second image relative to said first image.

10. The apparatus of claim 4 which additionally comprises means for adjusting the brightness of said second image relative to said first image.

11. The apparatus of claim 8 which additionally comprises means for adjusting the brightness of said second image relative to said first image.

12. The apparatus of claim 11 in which said means for adjusting the brightness of said second image relative to said first image comprises a third computer program employed in the computer, said third computer program utilizing a third algorithm to obtain an operating setting of the first detector and to adjust as operating setting of the second detector to match the brightness of the first detector.

13. The apparatus of claim 12 in which said third algorithm utilizes a histogram of the first image comprised of a plurality of bins, each possessing a range of brightness for a particular number of pixels.

14. An X-ray laminography apparatus utilizing an X-ray detector spaced from a source of X-rays, and a computer, comprising:
a. an X-ray tube window, the X-rays from the source of X-rays passing through said window;
b. an X-ray image produced by the X-ray detector of X-rays passing through said window;
c. means for locating the position of the detector relative to the X-ray source comprising:
a mask interposed the X-ray source and the X-ray detector to form a reference pattern in said X-ray image.

15. The apparatus of claim 14 in which said mask comprises:
a. a frame,
b. a first element held by said frame proximally positioned relative to the X-ray source; and
c. a second element held by said frame distally positioned relative to the X-ray source.

16. The apparatus of claim 15 in which said first element comprises a square like object and said second element comprises a cross-like object.

17. The apparatus of claim 14 in which said means for locating the position of the X-ray detector relative to the X-ray source further comprises a detector positioning computer program employed in the computer, said detector positioning computer program utilizing a detector positioning algorithm for locating the position of the detector relative to the X-ray source based on said reference pattern formed by said mask.

18. An X-ray laminography apparatus utilizing at least an apparatus for imaging an object utilizing at least a first and a second X-ray detector spaced from a source of X-rays and a computer,
comprising:
a. an X-ray tube window, the X-ray from the source of X-rays passing through said window
b. means for obtaining a first image from the first X-ray detector of X-rays passing through said window;
c. means for obtaining a second image from the second X-ray detector of X-rays passing through said window of means for adjusting the brightness of said second image relative to said first image, said means further comprising a brightness adjustment computer program employed in the computer, said brightness adjustment computer program utilizing a brightness adjustment, algorithm to obtain an operating setting of the first detector and to adjust an operating setting of the second detector to match the brightness of the first detector.

19. The apparatus of claim 18 in which said brightness adjustment algorithm utilizes a histogram of the first image comprised of a plurality of bins each possessing a range of brightness.
